(19) United States
(12) Patent Application Publication
(10) Pub. No.: US 2015/0067089 A1
(43) Pub. Date: Mar. 5, 2015

(54) METADATA DRIVEN DECLARATIVE CLIENT-SIDE SESSION MANAGEMENT AND DIFFERENTIAL SERVER SIDE DATA SUBMISSION

(71) Applicant: Juby Rajan, Bangalore (IN)

(72) Inventor: Juby Rajan, Bangalore (IN)

(73) Assignee: HINTROAPPS LIMITED, Dublin (IE)

(21) Appl. No.: 14/019,214

(22) Filed: Sep. 5, 2013

(51) Int. Cl. H04L 29/08

(52) U.S. Cl. CPC H04L 67/2819
USPC 709/213

(57) ABSTRACT

A method and system for managing declarative client-side session. The method includes caching data loaded by user interface (UI) associated with a client device operated by a user, and identifying one or more units of data and meta-information describing data to be accessed through the UI. Further, the method includes associating the one or more units of data with the identified meta-information, and constructing a declarative session in accordance to the association. Further, the method includes recording changes performed by the user on the one or more units of data, and submitting the recorded changes to a server in accordance to the declarative session.

### TECHNICAL FIELD

The present embodiments generally relates to client-side session management, and more particularly to a mechanism for managing meta-information driven declarative client-side session in web applications.

### BACKGROUND

Generally software developers often confront many difficulties in managing session layer for network distributed applications, such as Web applications. The web applications typically utilize N-tier architecture for managing, transferring, and controlling data over the network. Specifically, the N-tier architecture generally includes business application logic stored in one or more servers or layer of the servers. In that configuration, the application user interface (UI) can be stored in client device, while the application data can be stored in database servers. Such data can be highly un-persistent across different UI elements and typically managed by the web applications using user session(s). The management of such user sessions in distributed applications, particularly in the N-tier architecture, involves significant challenges for the software developers.

Different systems and methods are proposed to manage user sessions and control the data transfer. The conventional system allows the developers to manually write the code to create, manage, store, and control session data in the server(s). This increases the development cost, effort, and time of the developers for developing session management coding. Further, the server gets overloaded with the user session data which significantly increases the over system and network cost. With the advent of HTML5, Web 2.0, Web 3.0, and the like revolutions, the browser is not just restricted to a HTML renderer but, a platform with powerful features. This allows the conventional systems to manage the user sessions at the client-end which involves a significant development cost, effort and time of the developers for developing such session management coding. Furthermore, such systems may submit entire data to the server even when a unit of data is modified by user, which significantly increases the overall system and network cost. Thus, there remains a need of a robust system and method for effectively managing client-side session in web applications at a reasonable system and network cost.

### BRIEF DESCRIPTION OF FIGURES

This embodiments is illustrated in the accompanying drawings, throughout which like reference letters indicate corresponding parts in the various figures. The embodiments herein will be better understood from the following description with reference to the drawings, in which:

FIG. 1 is a diagram illustrating, among other things, a high level overview of a system, according to embodiments as disclosed herein;

FIG. 2 shows example illustration of key-value pair of data maintained in data cache, according to embodiments disclosed herein;

FIG. 3 shows example illustration of key-value pair of data maintained in record cache, according to embodiments disclosed herein;

FIG. 4A and 4B is a diagram showing an example illustration of path as described in the FIG. 3, according to embodiments disclosed herein;

FIG. 5 is a flow chart illustrating a method for managing declarative client-side session, according to embodiments disclosed herein; and

FIG. 6 depicts a computing environment implementing the system and method, in accordance with various embodiments of the present Embodiments.

### DETAILED DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The embodiments herein achieve a method and system for managing declarative client-side session. Unlike conventional systems, the declarative client-side session management in web application uses a meta-information driven declarative setup to manage user session data on User Interface (UI) at the client-side without any explicit coding by developers. The developers may configure data relations and session persistence through the meta-information. In an embodiment, the meta-information described herein can be used to describe data or data sections that may be accessed or modified through the various UI's. In an embodiment, the method includes caching data loaded by the UI associated with a client device operated by a user. The data described herein can be overall content loaded on the client device by one or more web applications. The user can access the web applications using one or more Unique Resource Locators (URLs). Further, the method includes identifying one or more units of data and meta-information describing data to be accessed through the UI and associating the one or more units of data with the identified meta-information. A declarative session can then be constructed in accordance to the association of the one or more units of data and the identified meta-information. Unlike conventional systems, the declarative session can be used to track the modifications performed by the user on the data and submit the modified units of data instead of submitting the entire data to a server for the purpose of updating, controlling, managing, and the like. Furthermore, the changes preformed by the user on the one or more units of data can be recorded and submitted to the server in accordance to the declarative session.

The method and system disclosed herein is dynamic, robust, and reliable for managing meta-information driven declarative client-side sessions in web applications. With the advent of HTML5, Web 2.0, Web 3.0, and the like revolutions, the browser is not just restricted to a HTML renderer but, a platform with powerful features. The proposed system and method can be used to enhance the powerful features of modem day browsers to use a declarative client-side sessions management approach through metadata and configurations. Unlike conventional systems, the meta-information driven declarative setup can be used to manage declarative client-side session management data on browsers without any explicit coding by developers. The system and method can be used significantly reduce development cost, effort, and time, as there is no need of session management coding by the developers. The declarative session can be used to track the modifications performed by the user on the data and submit the modified units of data instead of submitting the entire data to the server. The use of such declarative sessions particularly benefits the users with limited or slow bandwidth connections and reduces the overall system and network cost. Further, the system and method can be used to reduce the load or burden of the servers as the user sessions and associated session data are not managed at the server-side which further improves the scalability of the server and overall system at a reasonable system and network cost. The session data can be individually created and stored on each client device. Such differential storage of the session data can be used to efficiently manage the user sessions in distributed web applications, particularly in the N-tier architecture.

The present Embodiments can be implemented in a metadata-driven declarative session generator. The declarative session generator can be a computer program or a software module that can execute either independently as a stand-alone application, or dependently through a content browser such as a Web browser. When implemented as a dependent application, the metadata-driven declarative session generator can be a network distributable applet, reference script, executable computer code, computer-readable instructions, Java script, HTML (Hyper Text Markup Language) script, software widget, web widget, browser plug-in, or the like Importantly, the metadata-driven declarative session generator can dynamically generate a declarative session to track the modifications performed by the user on the data and submit the modified units of data instead of submitting the entire data to the server without requiring the developers to develop explicit instructions or session management codes. Furthermore, the proposed system and method can be implemented using existing infrastructure, components, and modules, and may not require extensive set-up or instrumentation.

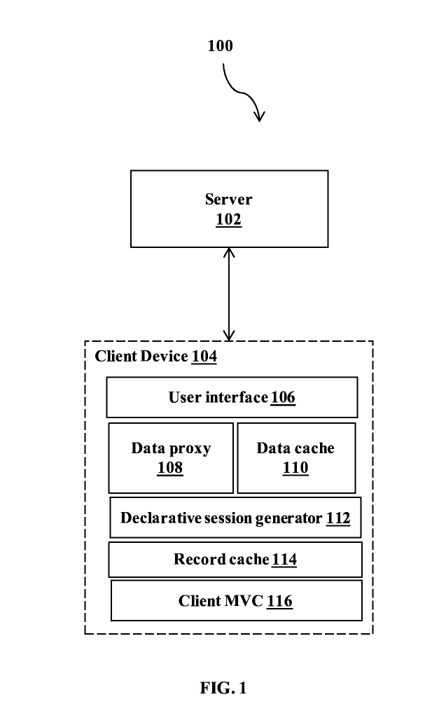

Referring now to the drawings, and more particularly to FIGS. 1 through 6, where similar reference characters denote corresponding features consistently throughout the figures, there are shown preferred embodiments.

FIG. 1 illustrating generally, among other things, a high level overview of a system 100 for dynamically generating a declarative session in an n-tier computing environment, according to embodiments as disclosed herein. In an embodiment, the system 100 can include a server 102 and a client device 104 communicating among each other over a communication network. In an embodiment, the communication network described herein can include for example, but not limited to, wireless network, wire line network, cellular network, global system for mobile communication, local area network, wide area network, personal network, private network, public network such as the Internet, a combination thereof, or any other network. In an embodiment, the client device 104 described herein can include for example, but not limited to, desktop, computer, mobile phone, smart phone, consumer electronic device, server, or any other electronic device. In an embodiment, the client device 102 can be configured to include a user interface (UI) 106 (also referred as browser), data proxy 108, data cache 110, declarative session generator 112, record cache 114, and client Model-View-Controller (MVC) 116.

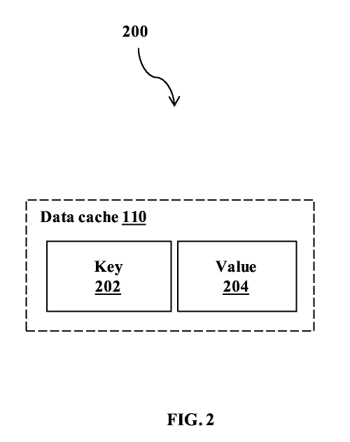

In an embodiment, the client device 104 can be configured to use the UI 106 to access web applications hosted or stored at the server 102. Notably, the UI 106 can be a content browser, a web browser, or other any application suitable for communicating, transferring, controlling, managing, and displaying data either in a desktop or handheld environment. In an embodiment, the data proxy 108 can be configured to intercept all data load requests from the UI to the server 102. In an embodiment, the data cache 110 can be configured to cache all the data loaded by the UI 106. The data cache 110 described herein can acts as a single pool of data across various components. The Data cache 110 can be configured to span across multiple UI components and pages such as to merge the data associated with the web applications as a single pool. The data described herein can be overall content loaded on the client device by one or more web applications. In an embodiment, the data may correspond to a pre-configured computing process. In an embodiment, the data cache 110 can be configured to store the data using a key-value pair technique, such as described in conjunction with the FIG. 2.

In an embodiment, the declarative session generator 112 can be configured to generate a declarative session on the client device 102. Unlike conventional systems, the declarative client-side session management in the web application uses a meta-information driven declarative setup to manage user session data on UI 106 on the client device 102 without any explicit coding by developers. In an embodiment, the meta-information described herein can be used to describe data or data sections that may be accessed or modified by the users through the various UI's. The developers may configure data relations and session persistence through the meta-information. In an embodiment, the declarative session generator 112 can be configured to identify one or more units of data and the meta-information describing data to be accessed by the user through the UI 106. In an embodiment, the one or more units of data may correspond to a pre-configured computing process. In an embodiment, the declarative session generator 112 can be configured to associate the one or more units of data with the identified meta-information and construct a declarative session in accordance to the association of the one or more units of data and the identified meta-information. Unlike conventional systems, the declarative session can be used to track the modifications performed by the user on the data and submit the modified units of data instead of submitting the entire data to the server 102 for the purpose of updating, controlling, managing, and the like. In an embodiment, the declarative session generator 112 can accommodate the pre-configured computing process specified by the one or more units of data in the declarative session. In an embodiment, the declarative session can include declarative tag and declarative directive specifying the meta-information related to the one or more units of data.

In an embodiment, the declarative session generator 112 can be configured to cooperatively execute with the UI 106. In an embodiment, the declarative session generator 112 can cooperatively execute with the UI 106 in several ways. For example, the declarative session generator 112 can be embedded or integrated in the browser as a reference script, executable computer code, computer-readable instructions, Java script, applet, HTML (Hyper Text Markup Language) script, software widget, web widget, browser plug-in, or the like. In another embodiment, the declarative session generator 112 can be a stand-alone application which can execute in the absence of the browser. In an embodiment, the declarative session generator 112 can cooperatively executes with the browser and dynamically activated upon the retrieval of data from the server 102. Further, the declarative session generator 112 can be implemented as a computer program, a software module, a hardware module, or a combination thereof.

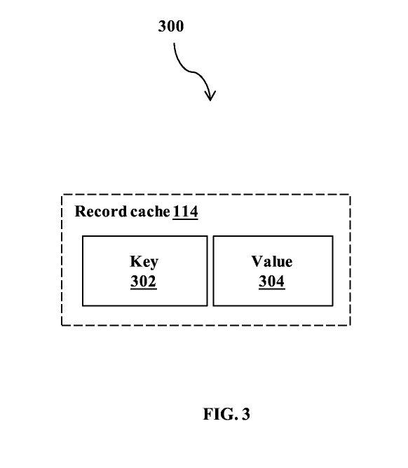

In an embodiment, the record cache 114 can be configured to record the changes performed by the user on the one or more units of data. The record cache 114 can be used to act as an client-side repository to store the data already loaded from the server 102 and records changes performed to the units of data by the user such that only the modified units of data can be submitted to the server 102, instead of submitting the entire data, in accordance to the declarative session. In an embodiment, the record cache 114 can be configured to store the units of data using a key-value pair technique such as described in conjunction with the FIG. 3.

In an embodiment, the client MVC 116 can be configured to listen for any changes or events performed on the UI 106 and update the data cache 110 with the changes. The MVC acts as a framework that enables the system 100 to reuse existing channel-specific authoring tools and interact in parallel with the same information via a multiplicity of channels, devices, or UI's, while presenting a unified, synchronized view of such information across the various channels, devices or UI's. In an embodiment, the web application frameworks and development tools are preferably based on the MVC paradigm that can be adapted to efficiently manage the user sessions in distributed web applications, particularly in the N-tier architecture. In an embodiment, when the UI 106 requests to save the changes to data in the server 102, the client MVC 116 can be configured to return the modified units of data from the data cache 110 in accordance to the declarative session. The modified data load is differential in that it returns only the units of data on which the changes are performed thereby reducing the amount of data transferred for submission to the server 102.

The FIG. 1 shows an exemplary overview of the system 100 but, it is to be understood that another embodiment is not limited thereto. Further, the system 100 can include different modules communicating among each other along with other hardware or software components. For example, the component can be, but not limited to, a process running in the electronic device, an executable process, a thread of execution, a program, and/or a computer. By way of illustration, both an application running on an electronic device and the electronic device can be the component.

FIG. 2 shows example illustration 200 of key-value pair of data maintained in the data cache 110, according to embodiments disclosed herein. In an embodiment, the data cache 110 can be configured to cache all the data loaded by the UI 106. The data described herein can be overall content loaded on the client device by one or more web applications. In an embodiment, the data may correspond to a pre-configured computing process. The data cache 110 described herein can act as an underlying pool of data where the data bound to different components are merged, such as to allow changes made to the data in one view available on other views in the same session. The Data cache 110 can be configured to span across multiple UI components and pages such as to merge the data associated with the web applications as a single pool of data.

In an embodiment, the data cache 110 can be configured to store the data using a key 202 and a value 204 pair technique. The key 202 described herein can include for example, but not limited to, URL of the web application, method name, UI component identifier, and the like. The value 204 described herein can include for example, the entire data loaded from the server 102 along with merged un-submitted modifications. In an embodiment, the data cache 110 can be a hash-map which may include data load configuration as the key 202 and the data as the value 204. For example, if the web application includes an employee table then the data cache 110 can store the component identifier along with the primary key field of the employee table in the key 202 and the actual data associated with each cell of the employee data in the value 204.

FIG. 3 shows example illustration 300 of key-value pair of data maintained in the record cache 114, according to embodiments disclosed herein. In an embodiment, the record cache 114 can be configured to record the changes performed by the user on the one or more units of data. In an embodiment, the record cache 114 can be configured to store the units of data using a key 302 and a value 304 pair technique. The key 302 described herein can include for example, but not limited to, URL of the web application, method name, UI component identifier, and the like. The value 304 described herein can include for example, track of changes performed on the units of data along with merged un-submitted modifications. In an embodiment, the record cache 114 can be a hash-map which may include data load configuration as the key 202 and the data as the value 204. For example, if the web application includes an employee table then the record cache 114 can store the component identifier along with the primary key field of the employee table in the key 304 and the actual modified units of data associated with each cell of the employee data in the value 304. The record cache 114 can be used to act as an client-side repository to store the data already loaded from the server 102 and records changes performed to the units of data by the user such that only the modified units of data can be submitted to the server 102, instead of submitting the entire data, in accordance to the declarative session.

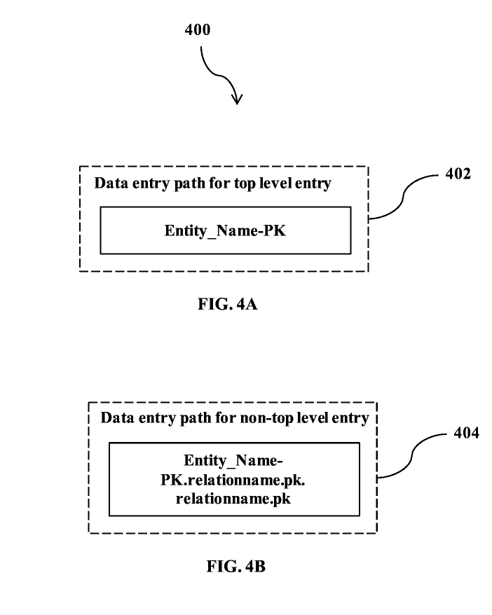

In an embodiment, inside both the data cache 110 and the record cache 114, a data record is identified through a path. The path described herein provides a detailed overview of top level entities and sub-entities to refer a specific unit of data. Further, the details related to the path are described in conjunction with the FIG. 4. The same units of data (identified by path in the data) across various UI components, can include different entries in the records cache 114 but only one entry in the data cache 110 such that the changes made to the units of data in one view can be effectively reflected across other views during the same declarative session. For example, when the UI 106 requests to save or store the changes to data in the server 102, the client MVC 116 can be configured to returns the modified units of data from the data cache 110 (including the merged long with merged un-submitted modifications recorded by the record cache 114) in accordance to the declarative session.

The modified data load is differential in that it returns only the units of data on which the changes are performed by the user. In an embodiment, the modifications performed by the user on the units of data can be submitted as a list of change messages to the server 102. Each change message can include elements such as for example but not limited to, the path (as described in the FIG. 4), a string value that uniquely identifies the units of data, a list of key value pairs with key being the name of the field being modified & value being the modified value, type of the modification indicated using a single character value with three possible values namely, “a for addition”, “m for modification”, and “d for deletion”, respective, and the like. The server 102 can be configured to iterate through each of the message, such as to perform modifications only to the modified units of data. The server side merging of already persisted data with the differential change submitted using the path (used as key in client cache) can be used to significantly decrease the overall system cost.

In an example, the server 102 can be configured to identify the units of data item that is affected from the path. If the change type indicates addition (a) then the server 102 can create a new instance of the respective data item and fill the field values from the key-value pair list. If the change type indicates modify (m) then the server 102 can load the units of data from persistent store and merge the field values with the loaded data using the key-value pairs available in the change message. If the change type indicates delete (d) then the server 102 can call the persistent store specific delete logic to delete the units of data. For example, for an Relational Database Management System (RDBMS) the delete logic can be for example, DELETE FROM <TABLE NAME> WHERE<PRIMARY_KEY>=<PRIMARY_KEY VALUE FROM CHANGE MESSAGE PATH>.

FIG. 4A and 4B is a diagram showing an example illustration 400 of path as described in the FIG. 3, according to embodiments disclosed herein. In an embodiment, inside both the data cache 110 and the record cache 114, a data record is identified through a path. The path described herein provides a detailed overview of top level entities and sub-entities to refer a specific unit of data.

The FIG. 4A shows an exemplary data entry path for top level entry. As shown at 402, the top level path entry may include an entity name associated with the primary key. For example, if an employee table includes a plurality of records reflecting employee identifier, employee name, department, and leave fields, then the top level path entry of the employee table can be represented as the employee identifier (which may be the primary key field to uniquely identify each record in the table).

Each data record can be associated with a multiple sub-entries. The FIG. 4B shows an exemplary data entry path for non-top level entry path. As shown at 404, the non-top level path entry may include an entity name associated with the primary key and other relationships (sub-entries). For example, if an employee table includes a plurality of records reflecting employee identifier, employee name, department, and leave fields, and the each field is interconnected to each other then the top level path entry of the employee table can be represented as the employee identifier (which may be the primary key field to uniquely identify each record in the table) along with other sub entries such as department, and leave fields.

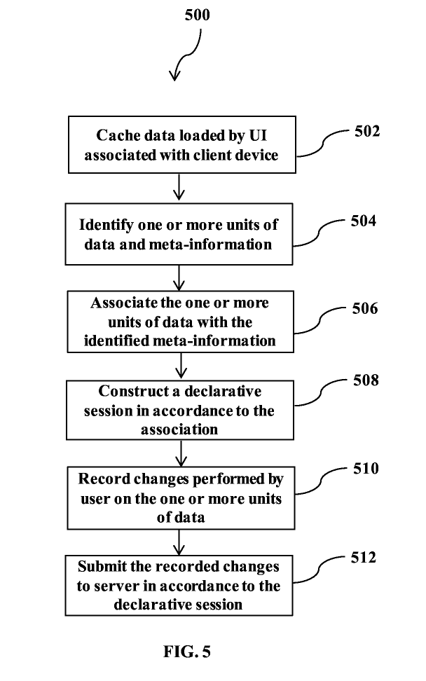

FIG. 5 is a flow chart illustrating a method 500 for managing declarative client-side session, according to embodiments disclosed herein. The method 500 and other description provide a basis for a control program which can be easily implemented using a microcontroller, microprocessor, or a combination thereof. In an embodiment, at 502, the method 500 includes caching data loaded by the UI 106 associated with the client device 104. The data described herein can be overall content loaded on the client device by one or more web applications. In an embodiment, the data may correspond to a pre-configured computing process. In an example, the method 500 allows the client device 104 to use the UI 106 to access web applications hosted or stored at the server 102. The method 500 allows the data proxy 108 to intercept all the data load requests from the UI to the server 102. The data cache 110 can be used to cache all the data loaded by the UI 106. The method 500 allows the data cache 110 to span across multiple UI components and web applications, such as to merge the data associated with the web applications as a single pool. Further, the method 500 allows the data cache 110 to store the data using the key-value pair technique.

In an embodiment, at 504, the method 500 includes identifying one or more units of data and meta-information describing data to be accessed through the UI. In an embodiment, the one or more units of data may correspond to a pre-configured computing process. In an example, the method 500 allows the declarative session generator 112 to identify the one or more units of data and the meta-information describing data to be accessed by the user through the UI 106.

In an embodiment, at 506, the method 500 includes associating the one or more units of data with the identified meta-information. In an example, the method 500 allows the declarative session generator 112 to associate the one or more units of data with the identified meta-information. In an embodiment, at 508, the method 500 includes constructing a declarative session in accordance to the association of the one or more units of data and the identified meta-information. Unlike conventional systems, the declarative client-side session management in the web application uses a meta-information driven declarative setup to manage user session data on UI 106 on the client device 102 without any explicit coding by developers. In an example, the method 500 allows the declarative session generator 112 to construct the construct a declarative session in accordance to the association of the one or more units of data and the identified meta-information. The method 500 allows the declarative session generator 112 to accommodate the pre-configured computing process specified by the one or more units of data in the declarative session. In an embodiment, the declarative session can include for example, but not limited to, declarative tag, declarative directive, and the like, specifying the meta-information related to the one or more units of data.

In an embodiment, at 510, the method 500 includes recording changes performed by the user on the one or more units of data. Unlike conventional systems, the declarative session can be used to track the modifications performed by the user on the data. In an example, the method 500 allows the record cache 114 to record the changes performed by the user on the one or more units of data such that only the modified units of data can be submitted to the server 102, instead of submitting the entire data, in accordance to the declarative session. The method 500 allows the record cache 114 to store the units of data using the key-value pair technique. The method 400 allows the client MVC 116 to listen for any changes or events performed on the UI 106 and update the data cache 110 with the changes.

In an embodiment, at 512, the method 500 includes submitting the recorded changes to the server 102 in accordance to the declarative session. Unlike conventional systems, the declarative session can be used to track the modifications performed by the user on the data and submit the modified units of data instead of submitting the entire data to the server 102 for the purpose of updating, controlling, managing, and the like. In an example, when the UI 106 requests to save the changes to the data in the server 102, the method 500 allows the client MVC 116 to return the modified units of data from the data cache 110 (including the merged long with merged un-submitted modifications recorded by the record cache 114) in accordance to the declarative session. The modified data load is differential in that it returns only the units of data on which the changes are performed thereby reducing the amount of data transferred for submission to the server 102. The method 500 allows the server 102 to receive the modifications performed by the user on the units of data as a list of change messages. Each change message can include elements such as for example but not limited to, a string value that uniquely identifies the units of data, a list of key value pairs with key being the name of the field being modified & value being the modified value, type of the modification indicated using a single character value with three possible values namely, “a for addition”, “m for modification”, and “d for deletion”, respective, and the like. The server 102 can be configured to iterate through each of the message, such as to perform modifications only to the modified units of data. The server side merging of already persisted data with the differential change submitted using the path (used as key in client cache) can be used to significantly decrease the overall system cost.

The various steps, blocks, operations, and acts described with respect to the FIG. 5 can be performed in sequential order, in random order, simultaneously, parallel, or a combination thereof. Further, in some embodiments, some of the steps, blocks, operations, and acts can be omitted, skipped, modified, or added without departing from scope of the Embodiments.

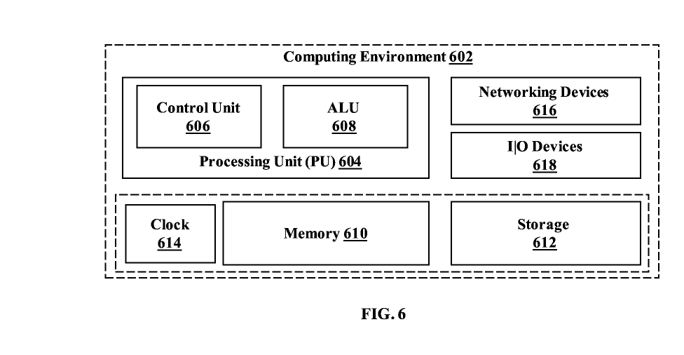

FIG. 6 depicts a computing environment 602 implementing the application, in accordance with various embodiments of the present Embodiments. As depicted, the computing environment 602 comprises at least one processing unit 604 that is equipped with a control unit 606 and an Arithmetic Logic Unit (ALU) 608, a memory 610, a storage unit 612, a clock chip 614, plurality of networking devices 616, and a plurality Input output (I/O) devices 618. The processing unit 604 is responsible for processing the instructions of the algorithm. The processing unit 604 receives commands from the control unit 606 in order to perform its processing. Further, any logical and arithmetic operations involved in the execution of the instructions are computed with the help of the ALU 608.

The overall computing environment 602 can be composed of multiple homogeneous and/or heterogeneous cores, multiple CPUs of different kinds, special media and other accelerators. The processing unit 604 is responsible for processing the instructions of the algorithm. The processing unit 604 receives commands from the control unit 606 in order to perform its processing. Further, any logical and arithmetic operations involved in the execution of the instructions are computed with the help of the ALU 608. Further, the plurality of process units may be located on a single chip or over multiple chips.

The algorithm comprising of instructions and codes required for the implementation are stored in either the memory unit 610 or the storage 612 or both. At the time of execution, the instructions may be fetched from the corresponding memory 610 and/or storage 612, and executed by the processing unit 604. The processing unit 604 synchronizes the operations and executes the instructions based on the timing signals generated by the clock chip 614. The embodiments disclosed herein can be implemented through at least one software program running on at least one hardware device and performing network management functions to control the elements. The elements shown in the FIGS. 1-6 include various units, blocks, modules, or steps described in relation with methods, processes, algorithms, or systems of the present Embodiments, which can be implemented using any general purpose processor and any combination of programming language, application, and embedded processor.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for managing declarative client-side session, the method comprising:
caching data loaded by user interface (UI) associated with a client device operated by a user;
identifying at least one unit of said data and meta-information describing data to be accessed through said UI;
associating said at least one unit of said data with said identified meta-information; and
constructing a declarative session in accordance to said association of said at least one unit of said data and said identified meta-information;
recording changes performed by said user on said at least one unit of said data; and
submitting said recorded changes to a server in accordance to said declarative session.

2. The method of claim 1, wherein said UI is a browser.

3. The method of claim 1, wherein said meta-information describes data to be accessed through said UI.

4. The method of claim 1, wherein said meta-information is pre-configured.

5. The method of claim 1, wherein said data corresponds to a pre-configured computing process.

6. The method of claim 1, wherein said at least one unit of said data corresponds to a pre-configured computing process.

7. The method of claim 1, wherein said declarative session accommodates said pre-configured computing process specified by said at least one unit of said data.

8. The method of claim 1, wherein said declarative session comprises at least one of declarative tag and declarative directive.

9. The method of claim 8, wherein said at least one of declarative tag and declarative directive specifies meta-information related to said at least one unit of said data.

10. The method of claim 1, wherein said data are cached using a data cache.

11. The method of claim 11, wherein said data cache caches said data using a key-value pair technique.

12. The method of claim 1, wherein said changes performed on said at least on unit of said data is recorded using a record cache.

13. The method of claim 12, wherein said record cache records said at least one unit of data using said key-value pair technique.

14. The method of claim 1, wherein said recorded changes are submitted to said server using a list of modification messages, wherein each message comprises at least one of a string value, type of change message, a list of key-value pair.

15. The method of claim 14, wherein said string value uniquely identifies said at least one unit of said data.

16. The method of claim 14, wherein said type of change message is a character value indicating at least one of addition, modification, and deletion.

17. The method of claim 14, wherein said server uses said list of change messages to merge persisted data with said submitted recorded changes.

18. A declarative session generator for managing client-side declarative session, wherein said declarative session generator is configured to:
cache data loaded by user interface (UI) associated with a client device operated by a user;
identify at least one unit of said data and meta-information describing data to be accessed through said UI;
associate said at least one unit of said data with said identified meta-information; and
construct a declarative session in accordance to said association of said at least one unit of said data and said identified meta-information;
record changes performed by said user on said at least one unit of said data; and
submit said recorded changes to a server in accordance to said declarative session.

19. The declarative session generator of claim 18, wherein said UI is a browser.

20. The declarative session generator of claim 18, wherein said meta-information describes data to be accessed through said UI.

21. The declarative session generator of claim 18, wherein said meta-information is pre-configured.

22. The declarative session generator of claim 18, wherein said data corresponds to a pre-configured computing process.

23. The declarative session generator of claim 18, wherein said at least one unit of said data corresponds to a pre-configured computing process.

24. The declarative session generator of claim 18, wherein said declarative session accommodates said pre-configured computing process specified by said at least one unit of said data.

25. The declarative session generator of claim 18, wherein said declarative session comprises at least one of declarative tag and declarative directive.

26. The declarative session generator of claim 25, wherein said at least one of declarative tag and declarative directive specifies meta-information related to said at least one unit of said data.

27. The declarative session generator of claim 18, wherein said declarative session generator is configured to cache said data using a key-value pair technique.

28. The declarative session generator of claim 18, wherein said declarative session generator is configured record said at least one unit of data using said key-value pair technique.

39. The declarative session generator of claim 18, wherein said recorded changes are submitted to said server using a list of modification messages, wherein each message comprises at least one of a string value, type of change message, a list of key-value pair.

30. The declarative session generator of claim 29, wherein said string value uniquely identifies said at least one unit of said data.

31. The declarative session generator of claim 29, wherein said type of change message is a character value indicating at least one of addition, modification, and deletion operation.

32. The declarative session generator of claim 29, wherein said server uses said list of change messages to merge persisted data with said submitted recorded changes.

33. A machine readable storage having stored thereon a computer program for managing declarative client-side session, wherein said computer program comprises a routine set of instructions causes said machine to:
cache data loaded by user interface (UI) associated with a client device operated by a user;
identify at least one unit of said data and meta-information describing data to be accessed through said UI;
associate said at least one unit of said data with said identified meta-information; and
construct a declarative session in accordance to said association of said at least one unit of said data and said identified meta-information;
record changes performed by said user on said at least one unit of said data; and
submit said recorded changes to a server in accordance to said declarative session.

34. The machine readable storage of claim 33, wherein said UI is a browser.

35. The machine readable storage of claim 33, wherein said meta-information describes data to be accessed through said UI.

36. The machine readable storage of claim 33, wherein said meta-information is pre-configured.

37. The machine readable storage of claim 33, wherein said data corresponds to a pre-configured computing process.

38. The machine readable storage of claim 33, wherein said at least one unit of said data corresponds to a pre-configured computing process.

39. The machine readable storage of claim 33, wherein said declarative session accommodates said pre-configured computing process specified by said at least one unit of said data.

40. The machine readable storage of claim 33 wherein said declarative session comprises at least one of declarative tag and declarative directive.

41. The machine readable storage of claim 33, wherein said data are cached using a data cache.

42. The machine readable storage of claim 41, wherein said data cache caches said data using a key-value pair technique.

43. The machine readable storage of claim 33, wherein said changes performed on said at least on unit of said data is recorded using a record cache.

44. The machine readable storage of claim 43, wherein said record cache records said at least one unit of data using said key-value pair technique.

45. The machine readable storage of claim 33, wherein said recorded changes are submitted to said server using a list of modification messages, wherein each message comprises at least one of a string value, type of change message, a list of key-value pair.

46. The machine readable storage of claim 45, wherein said string value uniquely identifies said at least one unit of said data.

47. The machine readable storage of claim 45, wherein said type of change message is a character value indicating at least one of addition, modification, and deletion operation.

48. The machine readable storage of claim 45, wherein said server uses said list of change messages to merge persisted data with said submitted recorded changes.
